(19) United States
(12) Patent Application Publication
(10) Pub. No.: US 2018/0357586 A1
(43) Pub. Date: Dec. 13, 2018

(54) SYSTEMS AND METHODS FOR HOLISTICALLY AND DYNAMICALLY PROVIDING QUINTESSENTIAL CONSEILLER FUNCTIONALITY

(71) Applicants: Patrick J. Goergen, Orlando, FL (US); Wendy A. Howell, Orlando, FL (US); Mark W. Hansen, Becker, MN (US); Derek M. Tishler, Indialantic, FL (US)

(72) Inventors: Patrick J. Goergen, Orlando, FL (US); Wendy A. Howell, Orlando, FL (US); Mark W. Hansen, Becker, MN (US); Derek M. Tishler, Indialantic, FL (US)

(21) Appl. No.: 15/973,403

(22) Filed: May 7, 2018

Related U.S. Application Data
(60) Provisional application No. 62/504,051, filed on May 10, 2017.

(51) Int. Cl. G06Q 10/06; G06Q 10/04; G06N 7/00; G06N 3/08

(52) U.S. Cl. CPC G06Q 10/06375; G06Q 10/04; G06N 3/08; G06N 7/005; G06Q 10/06393

(57) ABSTRACT

An AI-enabled Quintessential Conseiller (“QC”) system analyzes and advises a beneficiary's business. The QC system recognizes a plurality of patterns associated with beneficiary business data including clients and products or services, wherein the plurality of patterns are tracked by exploring strategic clustering visualizations of the beneficiary business data. The QC system then recommends improvement(s) to the beneficiary business, including improvements having an impact on beneficiary bottom line, and identifying areas requiring reformulation to move the beneficiary's business forward.

### CROSS REFERENCE TO RELATED APPLICATIONS

This non-provisional application claims priority to U.S. Provisional Application No. 62/504,051 filed May 10, 2017, of the same title, which application is incorporated herein in its entirety by this reference.

### BACKGROUND

The present invention relates to systems and methods for holistically and dynamically providing the functionality of an AI-based Quintessential Conseiller.

Many smaller businesses can benefit from a wide range of business advise/experiences, especially those started by entrepreneurs without formal business school training. The “school of hard knocks” is very unforgiving, time-consuming and/or costly.

While it may be reasonable for smaller businesses to outsource payroll, accounting, and sometimes HR, it is not pragmatic to outsource core business strategy and operations which are too important, strategic and individualized to be outsourced to third parties.

It is therefore apparent that an urgent need exists for an AI-based Quintessential Conseiller (“QC”) capable of learning and evolving to accommodate QC needs of specific beneficiaries, e.g., smaller businesses.

### SUMMARY

To achieve the foregoing and in accordance with the present invention, systems and methods for holistically and dynamically providing the functionality of an AI-based Quintessential Conseiller is provided.

In one embodiment, an AI-enabled Quintessential Conseiller (“QC”) system provides analysis and advice for a business associated with a beneficiary. The QC system recognizes a plurality of patterns associated with beneficiary business data including clients and products or services, wherein the plurality of patterns are tracked by exploring strategic clustering visualizations of the beneficiary business data. The QC system also recommends improvement(s) to the beneficiary business, including improvements having an impact on beneficiary bottom line, and identifying areas requiring reformulation to move the beneficiary's business forward.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a block diagram showing one embodiment of a Quintessential Conseiller (“QC”) Ecosystem, in accordance with the present invention;

FIGS. 2A-2F are slides illustrating the need for the embodiment of QC Ecosystem of FIG. 1;

FIGS. 3A-3G are slides illustrating the functionality of the embodiment of QC Ecosystem of FIG. 1; and

FIGS. 4A-4E are slides further illustrating the functionality of the embodiment of QC Ecosystem of FIG. 1.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

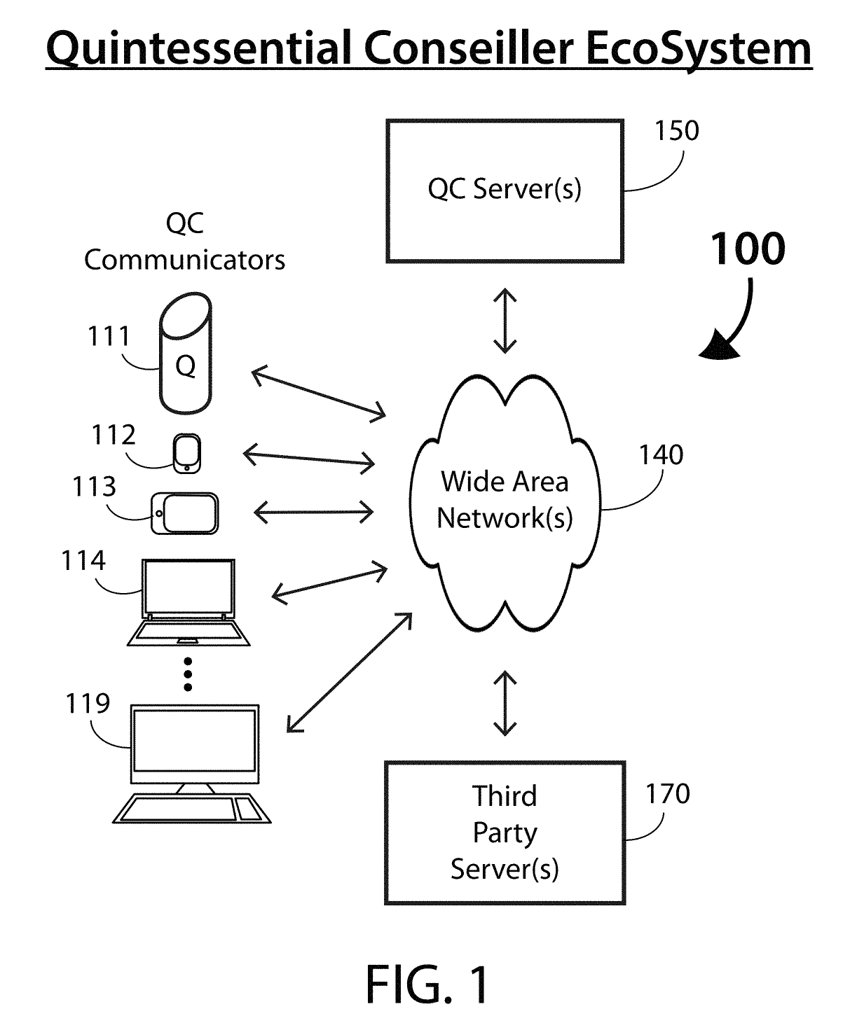

To facilitate discussion, FIG. 1 is a block-diagram of an exemplary Quintessential Conseiller (“QC”) Ecosystem 100 illustrating systems and methods for holistically and dynamically serving a plurality of QC beneficiaries (not shown) over wide area networks 140 (WANs) via any of a wide assortment of electronic network terminal devices, e.g., QC Communicators 111, 112, 113, 114 . . . 119. In the process of describing various exemplary embodiments, particular attention may be placed upon visual displays located on or coupled to mobile communication devices such as a dedicated Q device 111 or a smart phone 112. It is also contemplated that communications can be accomplished with many alternate forms of consumer electronic networked devices including, but not limited to, computers, tablet computer systems, e-reader devices, and virtually any electronic device which includes networking capability and a user interface.

While specific examples of visual user interfaces are described in great detail, QC Ecosystem 100 may be implemented with a wide range of interface types, including any combination of a visual display, tactile and audio output and a visual, tactile or acoustic user interface (UI). Further, although the Internet is a well-known convenient channel for communication between beneficiaries and QC Ecosystem 100. Equivalent communication over other WANs include services such as, but not limited to, Public Switched Telephone Network (PSTN), Voice over Internet Protocol (VoIP), Skype, WhatsApp, Facebook, SnapChat and Twitter.

Exemplary Communicators 111-119 represent the multiplicity of devices that can support access to QC Server(s) 150 of QC Ecosystem 100. Some of these communication devices are mobile devices—i.e., devices that can be carried easily from place to place by a beneficiary—typically with Wi-Fi or cellular data or other wireless connectivity and in numerous instances with built-in mobile telephone capability. However, less portable or fixed installation terminals may also support access to QC Server(s) 150.

In some embodiments, the QC functionality is concentrated in one or more of the QC Communicators 111-119, e.g., concentrated in exemplary Q device 111. In other words, in these embodiments, Q device 111 can provide full QC functionality via its own intranet and existing outside of a WAN 140. Hence Q device 111 can be implemented as part of an isolated network, e.g., an isolated Local Area Network (“LAN”) and create an intranet with web/domain server functionality for internal company operations. The isolated network can optionally be coupled to WAN 140 for additional capabilities.

In other embodiments, the QC functionality is distributed between one or more exemplary QC Communicators 111-119 and QC Server(s) 150. In yet other embodiments, the QC functionality is concentrated in QC Server(s) 150. Additionally, QC communications can be accomplished via a virtual private network (VPN) on top of WAN 140 thereby ensuring a secure communication channels with peripheral devices and enhancing beneficiary data security.

In addition to managing the QC needs of beneficiaries, QC Ecosystem 100 can adaptably enable a wide range of functionality such as: to advertise and offer QC-related Goods and Services (“QCGS”), accumulate independent third-party assessments and reviews, display credentials, leverage the draw of a centralized need-targeted electronic directory, offer informative mini-tutorials and FAQs, update and display availability status, prequalify prospective beneficiaries, provide repeatable direct beneficiary-facilitator communication, arrange for commercial transactions, facilitate and track progress towards consummating commercial transactions, consummate transactions for QCGS, follow-up post-transaction with beneficiaries to encourage and enhance good-will, and measure and evaluate the effectiveness of the foregoing and make adjustments and refinements. Some of the supplemental functionality of QC Ecosystem 100 can be supported by third parties resources via for example Third Party Server(s) 170.

Accordingly, some embodiments of QC Ecosystem 100 can provide a unified adaptable facility for beneficiaries, to prequalify, locate, evaluate, make repeatable contact with, and acquire QCGS, from, one or more QC facilitators (not shown). These QCGS facilitators and/or third parties may or may not be vetted and/or certified by the QC Ecosystem 100.

In some embodiments, current and future business metrics can be probabilistically modeled and forecasted via Bayesian Regression (Gaussian Process models) or Classification (Naive Bayes models). Such QC models and relating hyper parameters may be optimized via redundant Gaussian Process Hyper-parameter Optimization. Additionally, ensemble methods may be introduced to hedge out model risk by average results across multiple supervised machine learning models including but not limited to: Support Vector Machines, Nearest Neighbors, Decision Tree, Random Forest, Neural Networks or Deep Neural Networks (MLP, RNN, CONVO), AdaBoost, and QDA where applicable.

Distributed machine learning, to increase and or localize inference efforts, can be employed across QC Ecosystem devices using a closed, secure network and/or a WAN 140. Clients benefit from the use of structure-preserving encryption protocols to secure their data while preserving the ability to perform machine learning across secured pathways within local area network(s) and/or WAN 140. Accordingly the clients, i.e., beneficiaries, may opt to send encrypted data, anonymously, to a cloud based distributed machine learning systems via WAN 140 to reduce overhead on the Q device 111 without ever decrypting beneficiary data.

Some embodiments include a number of QC models including ensemble methods, with a primary focus on the implementation of probabilistic models to perform inferences, forecasts, and classifications using confidential client data. Some models may be pre-trained and/or use transference learning to increase the speed of model convergence on data provided by clients, i.e., beneficiaries. This ensures a quick convergence to a high precision in these models in relation to each particular client's needs. Using intelligent initialization of these models through pre-training, transference learning, or other proprietary preparations reduces the “energy” and time required to achieve value for the beneficiaries via quality model’ inferences.

Live beneficiary data can be compared against online probabilistic models in order to inform the business of unexpected volatility events in real time. This would increase the reaction time of beneficiaries, e.g., business owners, to ensure they can capitalize on, or correct against high impact developments in their business model. In addition to tacking volatility in metrics, the impact of each metric is analyzed to inform the business owner which metrics are moving the business, thereby enabling QC Ecosystem 100 to suggest areas where reinvestment or due diligence should be performing in the immediate future.

Additionally, analysis performed with Dimensionality Reduction/Feature Selection methods such as but not limited to: univariate feature selection, recursive feature elimination, or Tree-based feature selection, may be used to increase the accuracy of QC models or compress data by elimination superfluous data. The majority of QC models will feature a small to moderate computational overheard due to the relative size of the numerical data. Some optimizations may require a number of Central Processing Units (“CPU”s) with additional computing memory to quickly converge to good results.

Some embodiments may include Graphics Processing Units (“GPU”s). Although GPUs may provide less flexibility or incur delays associated with copying values to the GPU and back, in the case of processing very high dimension data, such as medium to large images, GPU(s) would be ideal for sub-minute turnaround of predictions in production (assuming supervised training, as opposed to online).

Machine Learning can be implemented in a black box, e.g. within exemplary Q device 111. Difficulties can be introduced when attempting to create a QC Ecosystem 100 which consistently delivers value to the beneficiary. The focus on collecting quality data ensures the inference architectures are resilient and of the highest quality.

Initialization is everything in the machine learning environment of GC Ecosystem 100, where starting a problem determines where it can finish. Imagine carving David from a marble block. What if Q device 111 can start halfway done? Imagine how much time and energy Q device 111 can save a beneficiary. That is the benefit of quality data, pre-processing, and the initialization of model “hyper-parameters”.

What can QC Ecosystem 100 provide businesses of beneficiaries?
Inform beneficiary of a breach in expected performance for their business metrics. What went right? What went wrong? For example, Q device 111 can quantify beneficiary performance against historical data and selected benchmarks to help make informed decisions about what is right and wrong with the business model.
Suggest areas for improvement that can have the highest impact in a beneficiary's bottom line while also identifying areas which may require reformulation to start moving the business forward.
Discover patterns in a beneficiary's business, clients, products, and anything that can be tracked by exploring strategic clustering visualizations of beneficiary data. (May make use of a supervised or unsupervised machine learning clustering algorithm).

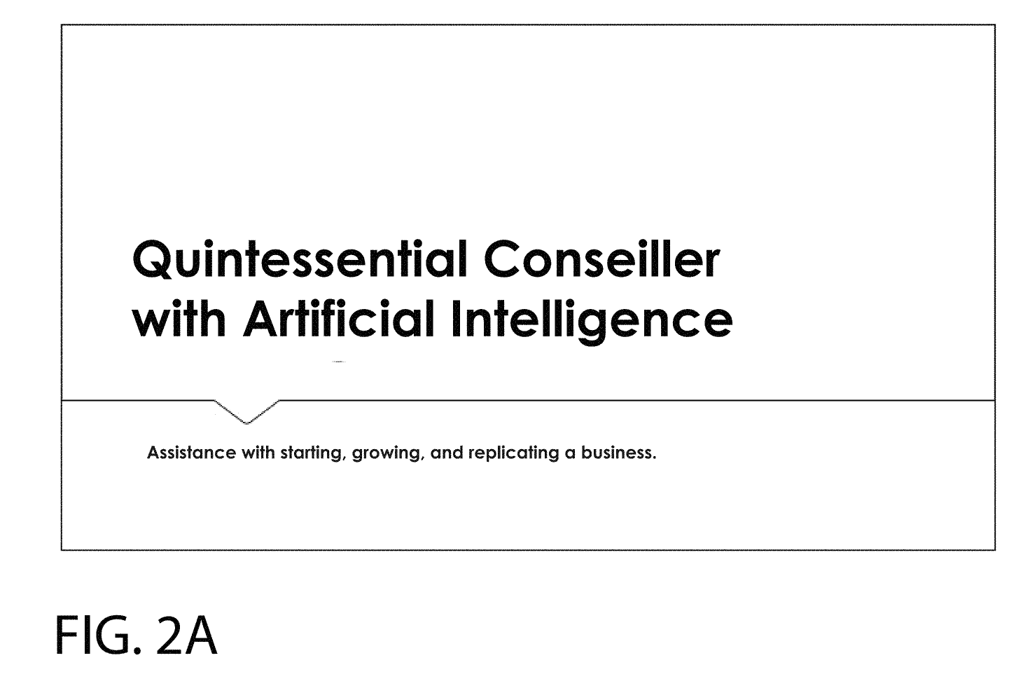

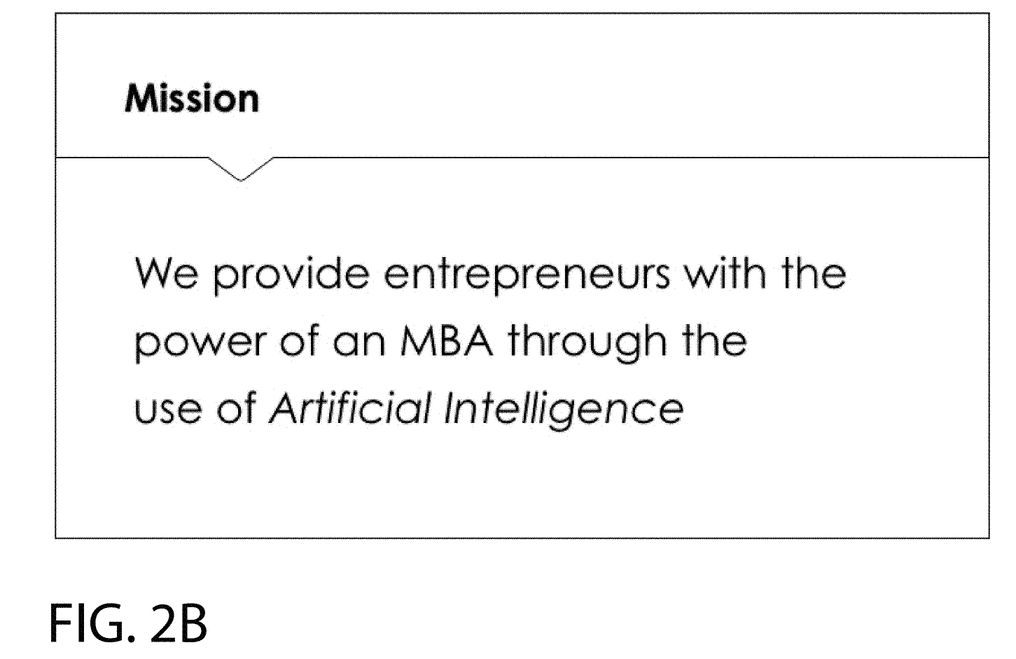

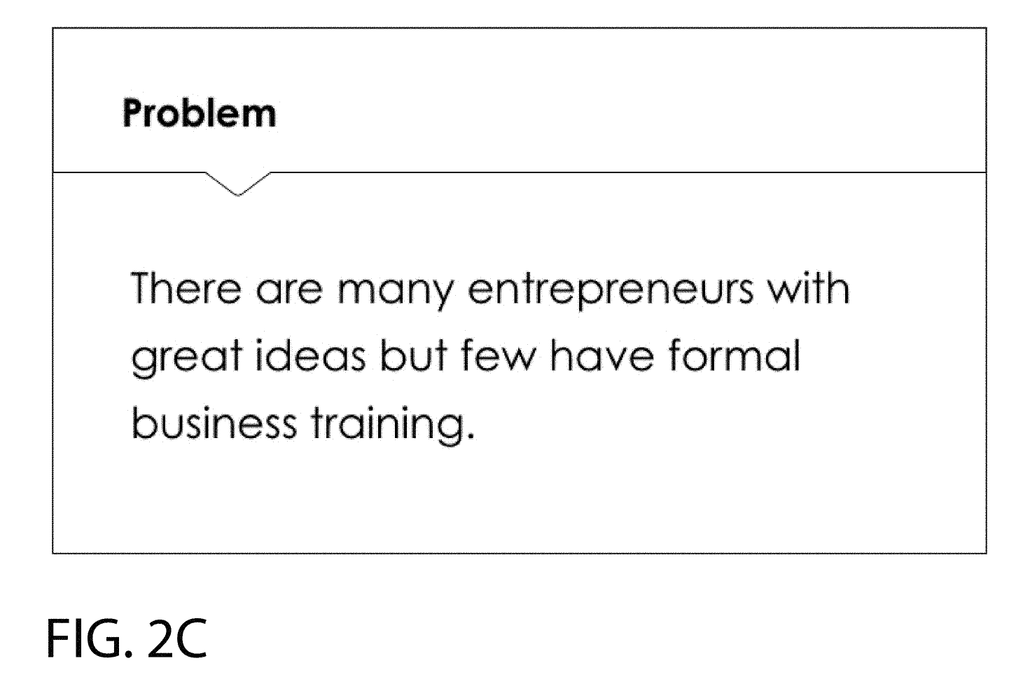

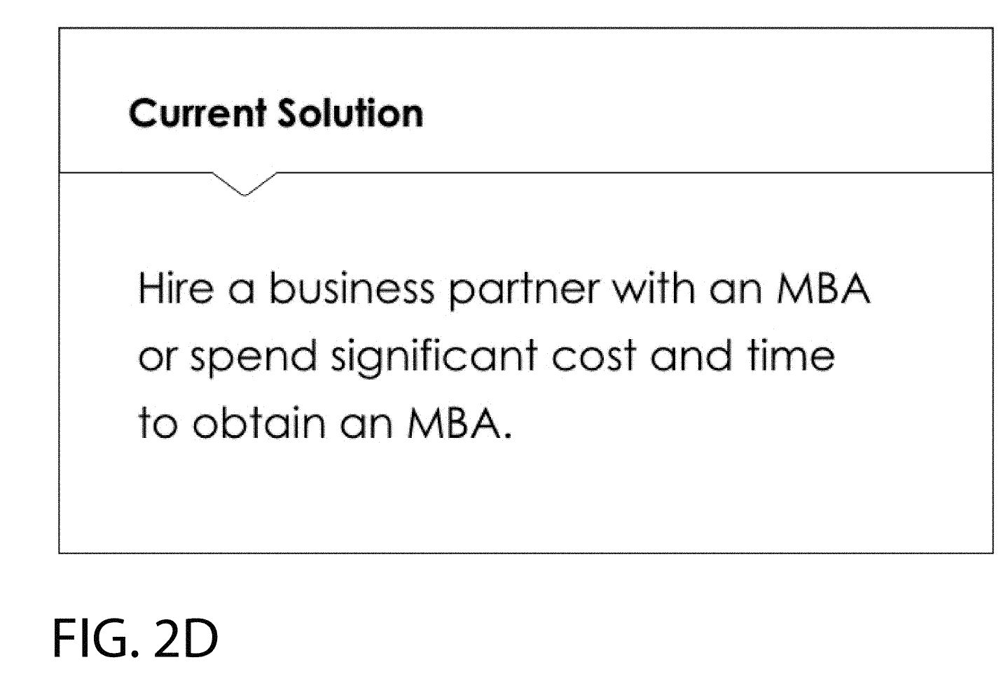

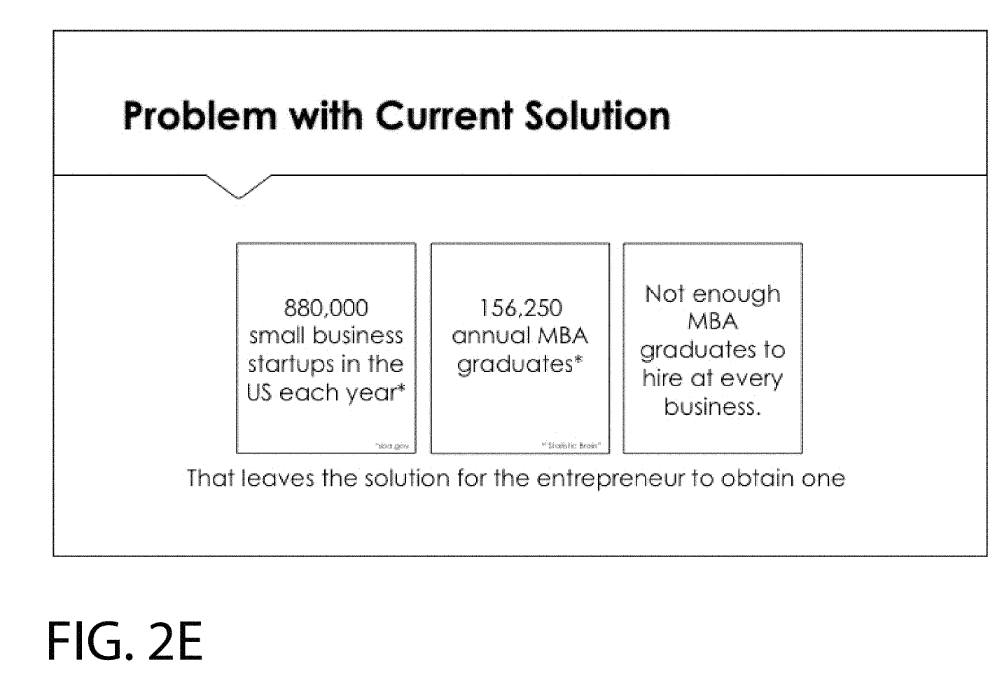

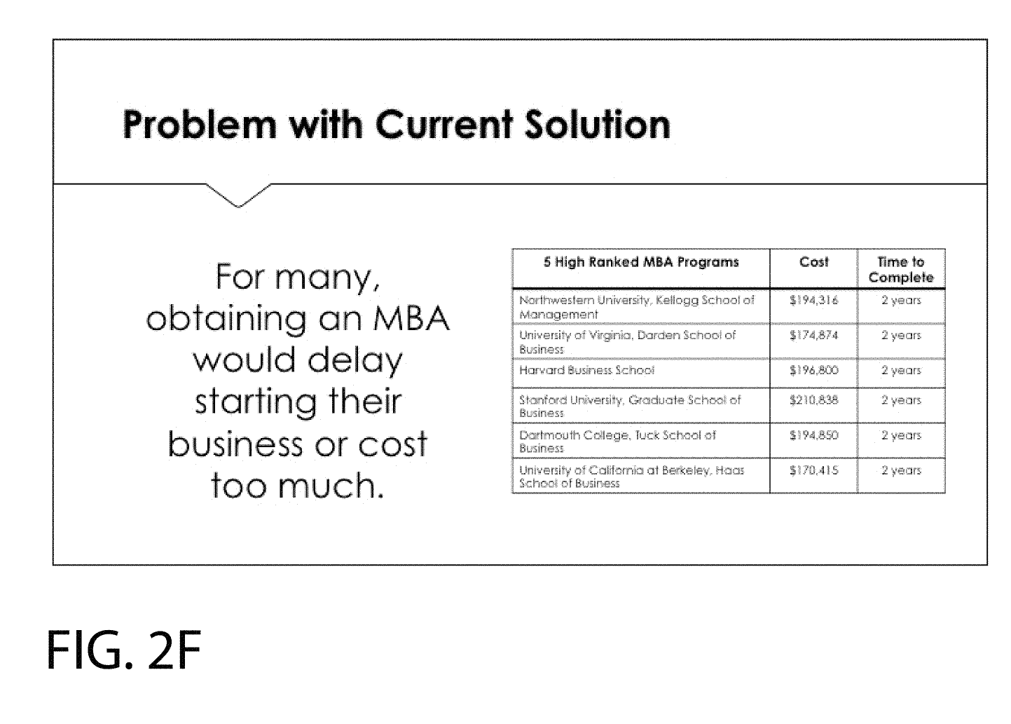

Referring to FIGS. 2A-2F, slides illustrating the need for the QC Ecosystem 100, the emphasis on servicing the beneficiary's business. The beneficiary, often an entrepreneurial business owner/operator/executive, owns their own data, tools, and any resulting AI custom models that are developed. A marketplace may be provided to assist the beneficiary monetize their AI models if they so chooses.

As shown in FIGS. 2B-2C, an MBA is somewhat of a misnomer, in that it is really providing the beneficiary with QC functionality to make insights and tools that a person with an MBA would generally be able to provide. Some embodiments incorporate Artificial Intelligence (AI) using machine learning, analytics, and market analysis but not limited to it. These embodiments may also use Natural Language Processing (NLP). Without such QC functionality or equivalent, businesses run the risk of premature failure that may be avoidable.

FIGS. 2D-2F further emphasize the need and demand for such QC functionality. The demand and supply, in for example the USA, for highly sought after MBAs from top programs are mismatched at best, resulting in unaffordability and/or unavailability for most smaller businesses. The alternative for most beneficiaries to acquire an MBA education is very impractical in time and/or cost. Top twenty MBA programs can cost between $170-200K and these MBA graduates expect to get paid that much to recoup their Return on Investment (“ROI”).

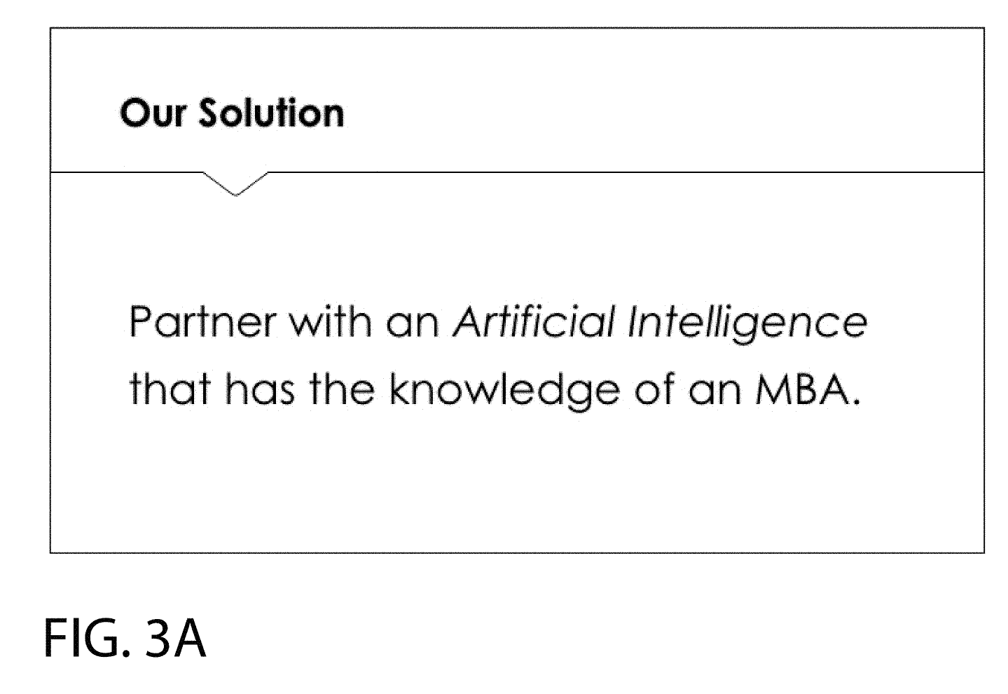

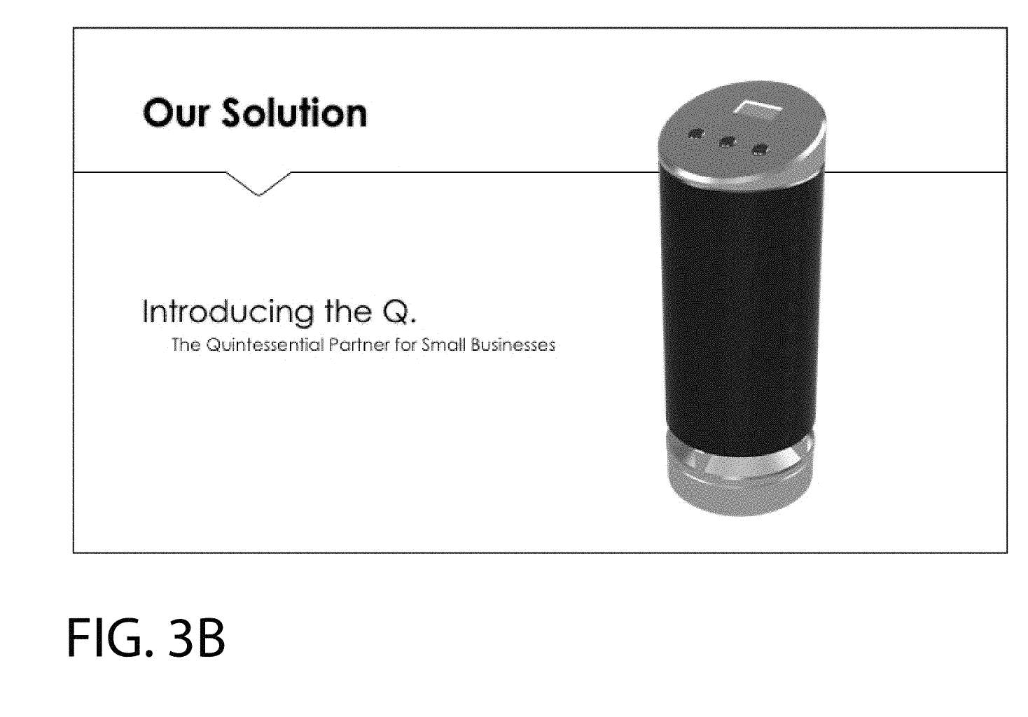

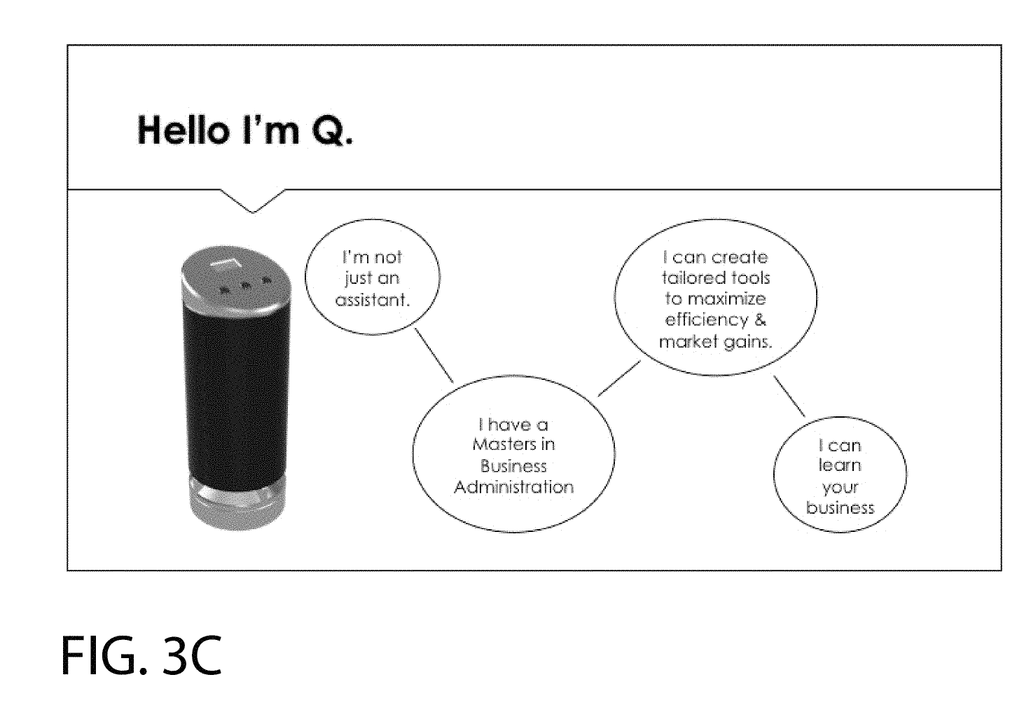

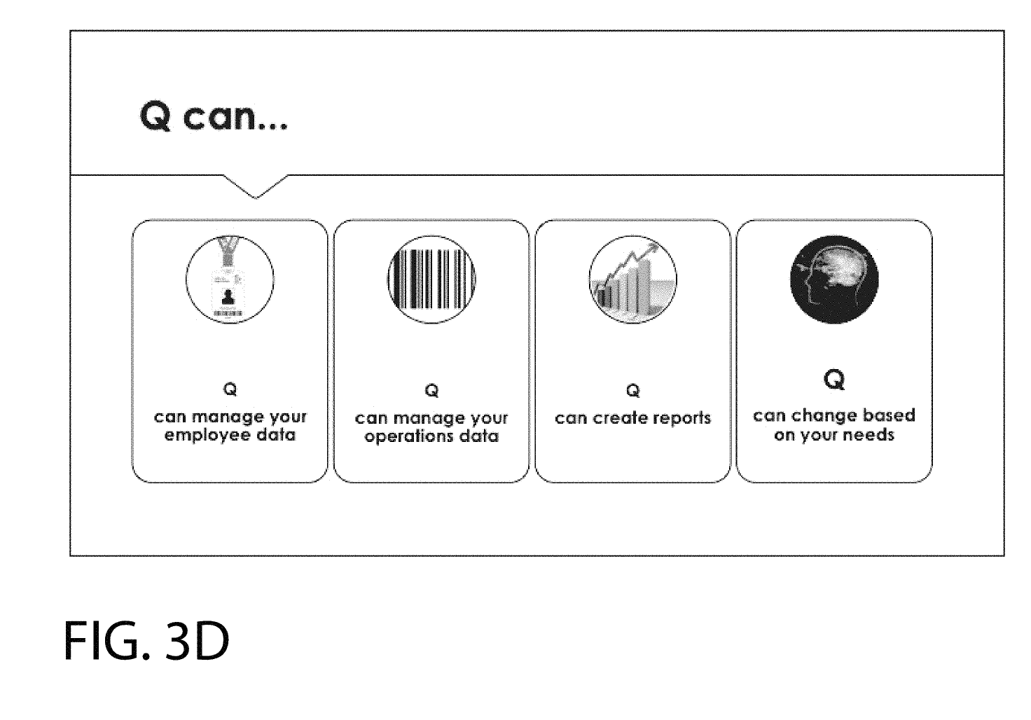

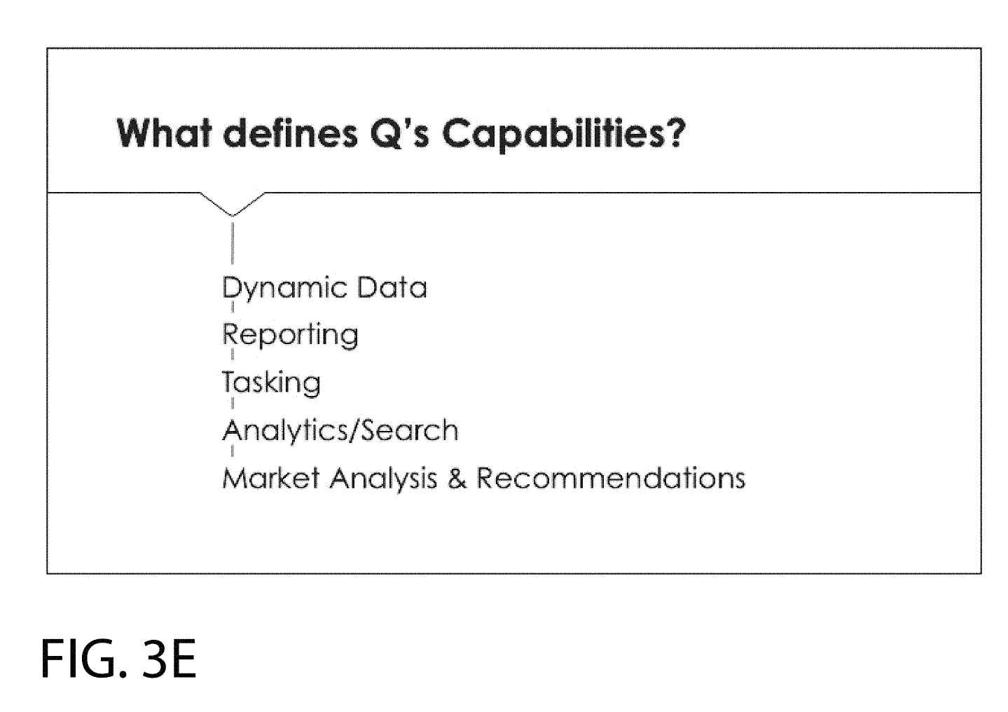

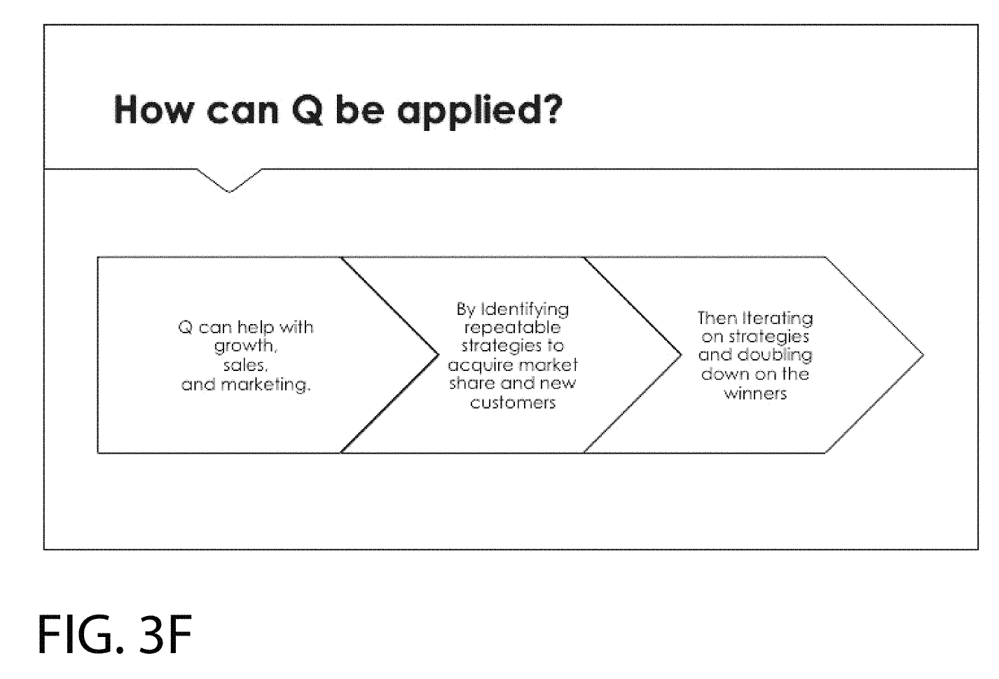

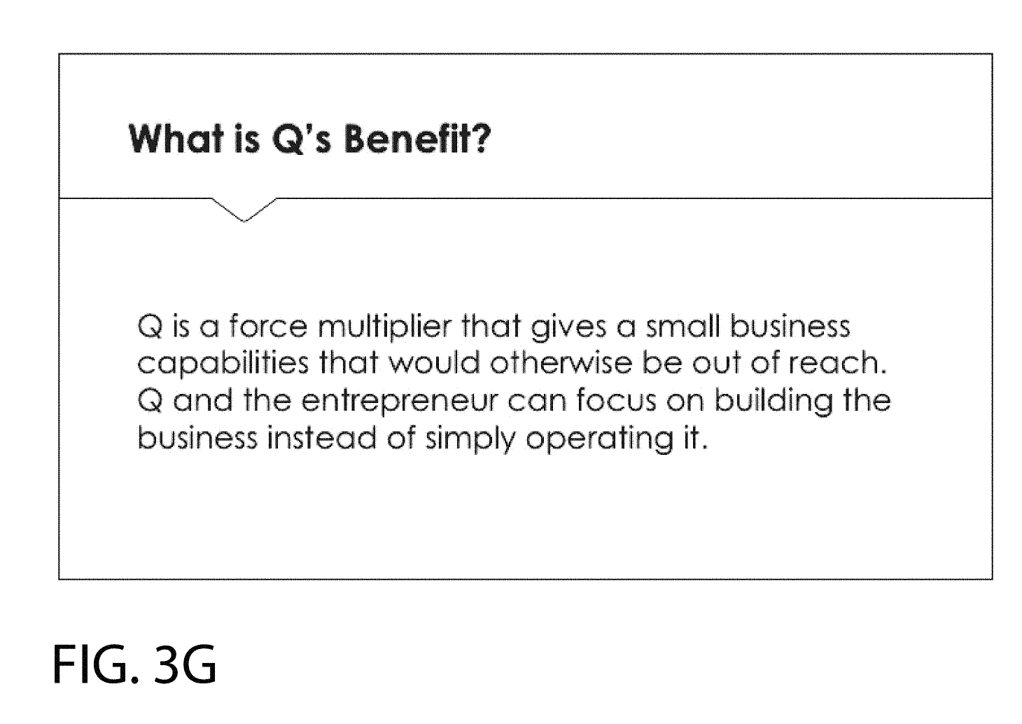

QC Ecosystem 100 provides a novel timely and cost-effective solution to this need by providing an AI-based “partner” and not the boss (see FIGS. 3A-3F). Ecosystem 100 is a tool to keep the business running smoothly but not there to be a “creative”, that is reserved for the human owner/operator. AI-based QC functionality may suggest that marketing is needed but will not necessarily create a marketing package for the product/service. The intent is to let the owner/operator know when it is time to act (not too early and not too late), and to provide real-time business state and operations data in a timely manner.

Hence, as illustrated by FIG. 3B, “Q” in the context of exemplary Q device 111, stands for Quintessential, in that Q device 111 can be a partner but is not intended to replace the boss. In other words, QC functionality can be viewed as a “Conseiller” or “Consigliere”. For example, in the consumer space, adoption and understanding of AI has increased with marketing efforts of Google and Amazon. The marketing came through a product innovation of giving the AI a physical form. Echo and Google Home are physical concepts of an AI that a consumer can easily grasp. These devices know they can ask that object a question and it can respond. It can be the source of satisfaction and frustration. This strategy will allow companies to release the same (slightly-updated) AI-based consumer product in a new physical form (change the form factor) and consumers may perceive as being a new product.

In this example, Q device 111 can do many things but most importantly is capable of learning. Q device 111 learns your business in order to dynamically make tools (software and/or hardware) that ensure the owner/operator and the business are efficient and can focus on the market. The knowledge of an MBA can be captured and provided as an AI-based QC functionality (see FIG. 3C).

In some embodiments, as illustrated by FIG. 3D, Q device 111 comes with some “out of the box” tools to manage employee data, operations data and create reports. But more importantly Q device 111 is capable of evolving by, for example, changing and/or creating your tools, and thereby reacting to individual needs. Most existing tools are inflexible and there is no technological reason for that limitation. Modifying a database generally involves several lines of code and user interfaces are generally dynamically generated. There is little business justification for a small business to pay for an expensive and inflexible solution. In general, business owners/operators are incapable of predicting most needs at the onset of the business. Q device 111 is a tool that makes this process easy and is cost effective.

The slide of FIG. 3E summarizes QC functionality (“Q”):
Dynamic Data—Database can be modified based on the needs of the business.
Security—Q could be placed on an isolated or non-isolated network to create an intranet with web/domain server functionality for internal company operations. The isolated network could be connected to the internet for additional capabilities. Additionally, Q automatically creates a Virtual Private Network (“VPN”) on top of any other network (LAN, WAN, Internet, Cellular networks, etc.) for it to securely communicate with peripheral devices ensuring the users security.
Reporting—Reports can be auto generated.
Tasking—Tasking software is built in but also can be auto tailored based on project types and needs.
Analytics/Search—Indexing, tokenizing and learning is all run on the data contained in the Q to make the businesses more transparent and searchable to the owner.
Market Analysis & Recommendations—Q can take the generated reports and securely compare them against market trends and make recommendations to the owner on how to act in the market condition.

As depicted by the slides of FIGS. 3F-3G, methodology taught in MBA programs can provide a great foundation for designing an AI-based QC Ecosystem 100 capable of learning a business and providing QC functionality. Most small businesses cannot afford the tools to be more efficient or even know what tools are needed to compete in the market. Q will focus on boiler plate operations and relieving the stress of organizing the business so the owner/operator can focus on growth and creativity. Business owners' bandwidth are often overwhelmed by spreadsheets, tax/finance docs, employee timecards etc. Q is designed to reduce that stress and act as a force multiplier to free up the entrepreneurs time for a healthier balance of owner/operator lifestyle.

In accordance with various embodiments of QC Ecosystem 100, a secure fee-based AI marketplace can be provided, enabling business owner/operator to monetize their AI-based data and any developed tools to third parties. Business owners can also implement QC functionality in compliance with an insurance policy requirement, bank loan collateral and/or an investment.

One form factor for providing QC functionality is as an All-In-One printer that enhances the operations of a business. Implications of printer-based QC solutions include sensitivity of beneficiary information. Printers already have screens, processors, printing, scanning, Wi-Fi, etc. built in. Taking privacy concerns into consideration, businesses can be equipped with, for example, “Brother Printers that have Q Intelligence inside.”

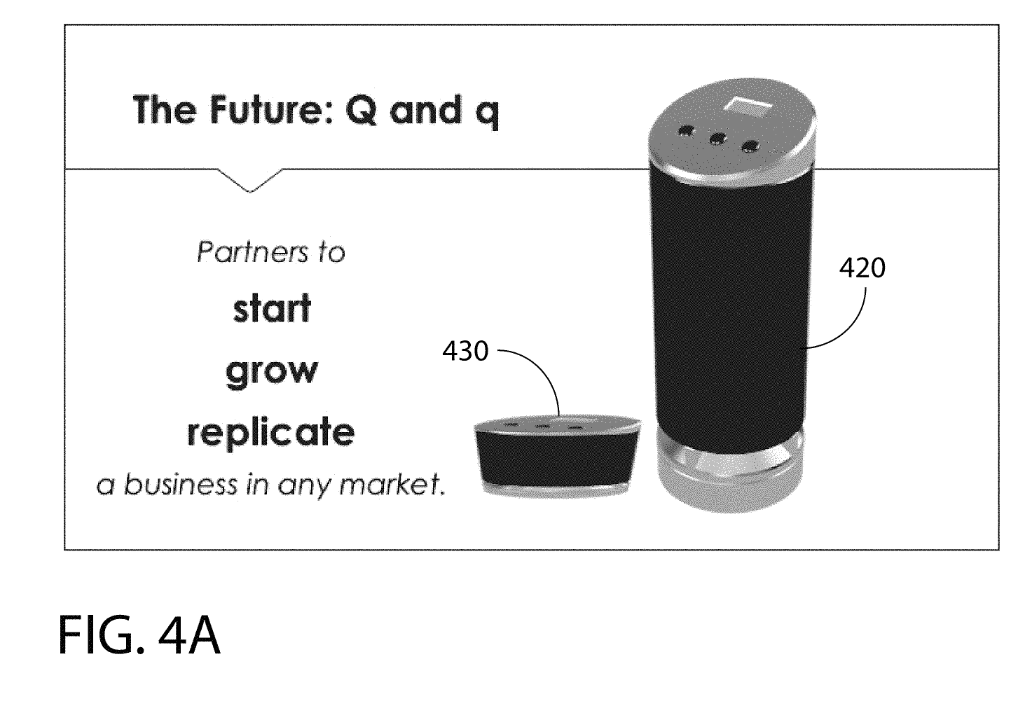

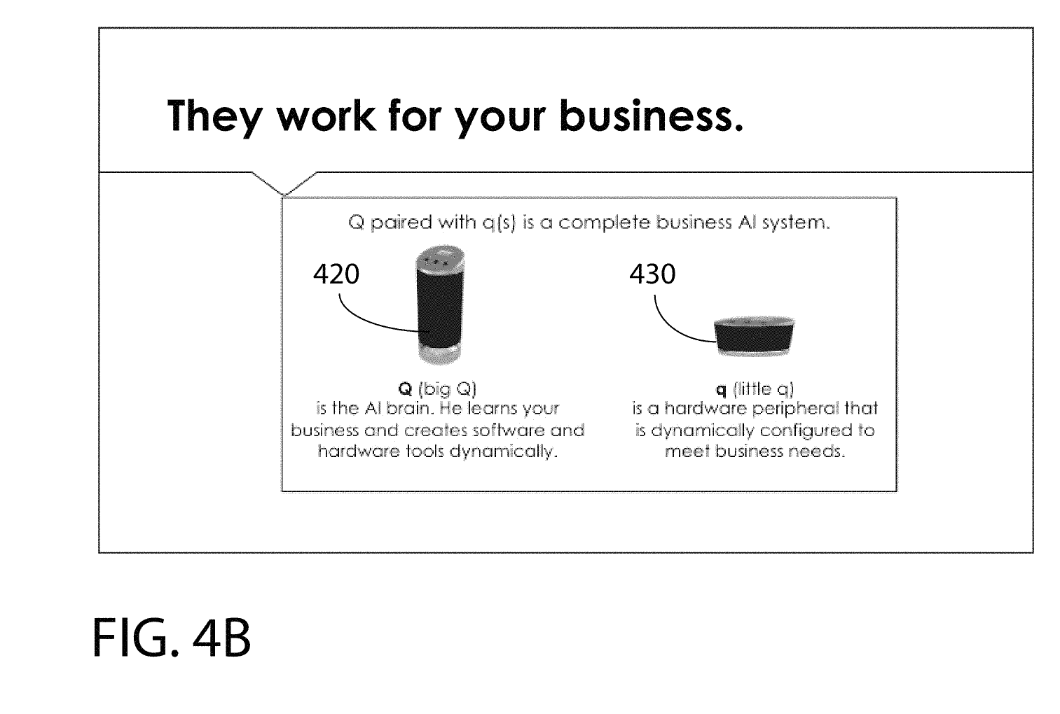

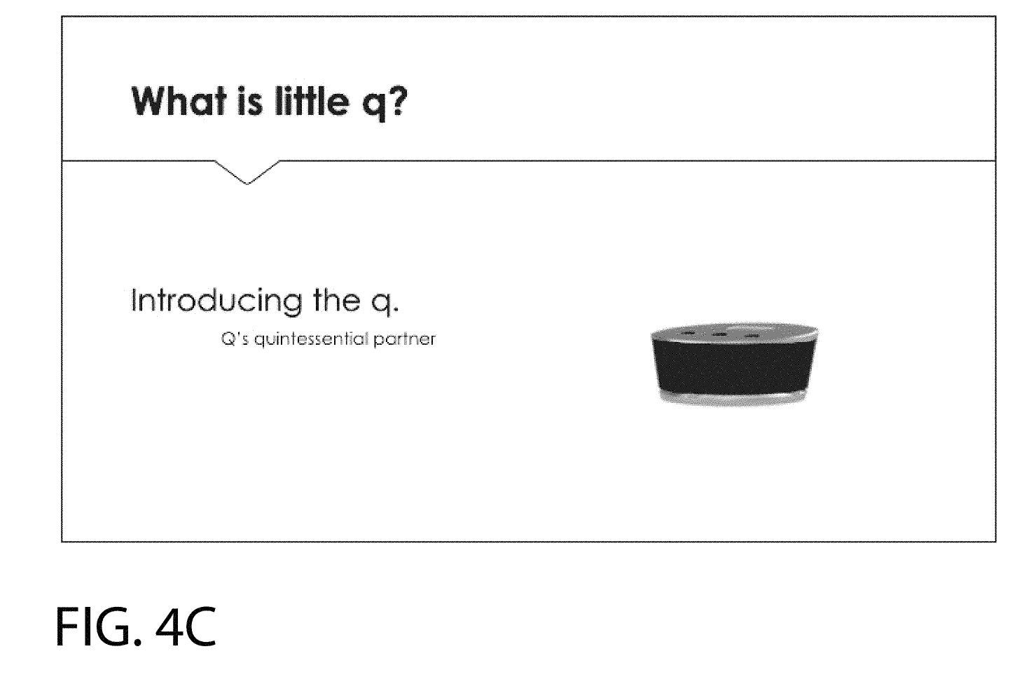

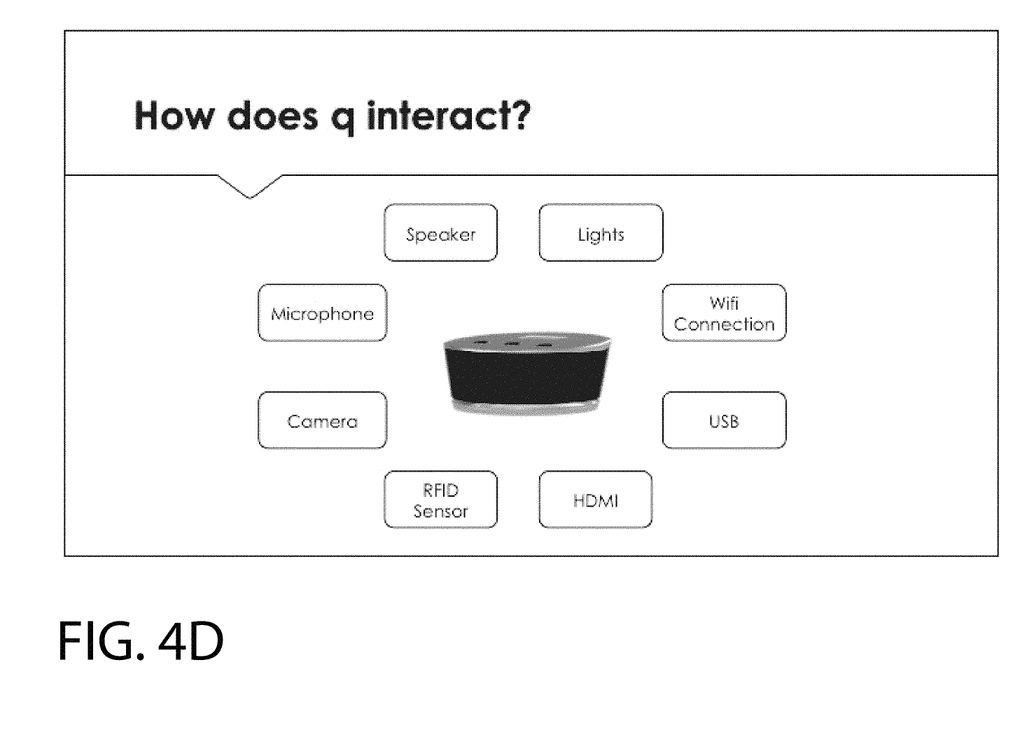

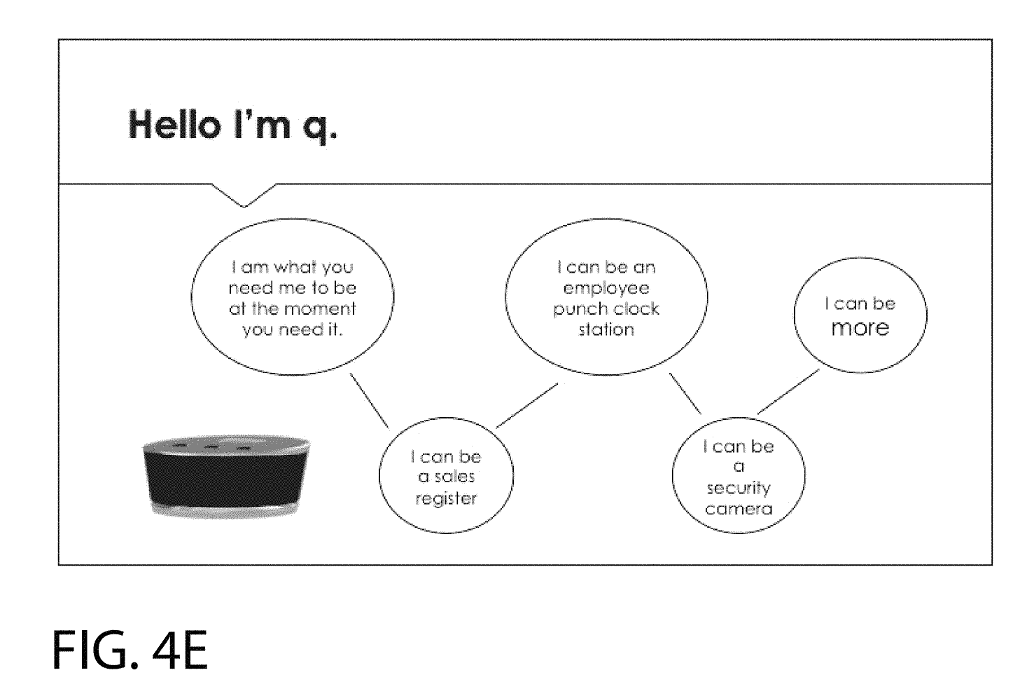

Referring to the slide of FIG. 4A, functionality of QC Ecosystem 100 can be scalable and/or distributable, with hardware implementations ranging from a Big Q 420 to a Little q 430. In this example, Ecosystem 100 can help start, grow, and replicate a business in a wide variety of business types. While learning the market of the beneficiary together, Little q 430 can provide quality supply data to Big Q 420.

Hence, as illustrated by FIGS. 4B-4C, Big Q 420 and Little q 430 can provide a complete and secure AI system for a small business. Big Q 420 can create an intranet and/or virtual private network to securely communicate with multiple peripherals including Little q 430. This addresses privacy and security concerns of the businesses. Little q 430 can be part of a dynamically configured hardware and software platform. Ecosystem 100 can continually evolve based on needs of the business. Little q 430 can be partnered with Q 420. For example, there can be multiple ‘little q’s (not shown) paired with a Big Q 420 in some configurations.

Little q(s) can include many sensors and they be combined to make them useful in different ways. By enabling and disabling components/sensors and by being dynamically configurable via Big Q 420, Ecosystem 100 provides for the creation of tools that a business owner/operator can utilize to do unique, innovative and efficient tasks tailored to their businesses. Big Q 420 can automatically create a network interface and/or a user interface based on the remote configuration of Little q 430. Little q 430 uses the user interface to provide data back to Big Q 420 (see FIG. 4D).

As shown in FIG. 4E, Little q 430 can be remotely configured by Big Q 420 using commands, including voice or web-based commands. For example:
“Q configures q 5 to be a cash register.”
“Q configures q3 to be a security camera and record from 2 am-7 am.”
“Q at 7 am configures q3 to be a punch clock.”

These exemplary configurations are possible through the enabling and/or disabling on onboard sensor(s) of Little q 430. Some aspects may have software user interfaces (like a sales register). In some embodiments, the interfaces are dynamically created based on the specific need. If customer phone numbers are required, then instruct Big Q 420 they are required, and the requirement(s) can be propagated, e.g., reflected on the user interface of Little q 430 interface (see FIG. 4E).

It is contemplated that QC Ecosystem 100 can be adapted to serve a wide range of business types, from non-profit organizations to for-profit organizations, including professional services organizations. For example, a non-profit organization such a local food bank can use QC functionality to match clients (e.g., homeless, disabled or laid-off) with Federal, State and/or local grants, thereby saving the team (often less than ten employees) many hours of browsing and phone calls securing funds to keep the food bank operational. Such QC functionality may also be used by the local food bank to source excess/expired food from local restaurants and/or grocery stores.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. An AI-enabled Quintessential Conseiller (“QC”) system for analyzing and advising a business associated with a beneficiary, the QC system configured to:
recognize a plurality of patterns associated with beneficiary business data including clients and products or services, wherein the plurality of patterns are tracked by exploring strategic clustering visualizations of the beneficiary business data; and
recommend at least one improvement related to the beneficiary business data, wherein the at least one improvement having an impact on beneficiary bottom line, and wherein the at least one improvement includes identifying areas requiring reformulation to move the business forward.

2. The QC system of claim 1 wherein at least one of the recognizing and recommending includes ensemble methods with probabilistic models for performing inferences, forecasts, and classifications using the beneficiary business data.

3. The QC system of claim 2 wherein the probabilistic models are pre-trained or includes transference learning to increase speed and precision of model convergence using the beneficiary business data.

4. The QC system of claim 2 wherein the probabilistic models include Bayesian Regression.

5. The QC system of claim 2 wherein the probabilistic models include supervised or unsupervised machine learning clustering algorithms.

6. The QC system of claim 5 wherein the supervised machine learning clustering algorithms include at least one of Support Vector Machines, Nearest Neighbors, Decision Tree, Random Forest, Neural Networks, Deep Neural Networks, AdaBoost, and QDA.

7. The QC system of claim 1 wherein the recommending includes providing at least one of reporting, tasking, analytics and market analysis.

8. The QC system of claim 1 wherein the recognizing includes identifying a breach in expected performance of beneficiary business metrics and quantifying beneficiary business performance against historical data and selected benchmarks, and wherein the recommending includes providing informed decisions related to the beneficiary business model.

9. In an AI-enabled Quintessential Conseiller (“QC”), a method for analyzing and advising a business associated with a beneficiary, the method comprising:
recognizing a plurality of patterns associated with beneficiary business data including clients and products or services, wherein the plurality of patterns are tracked by exploring strategic clustering visualizations of the beneficiary business data; and
recommending at least one improvement related to the beneficiary business data, wherein the at least one improvement having an impact on beneficiary bottom line, and wherein the at least one improvement includes identifying areas requiring reformulation to move the business forward.

10. The method of claim 9 wherein at least one of the recognizing and recommending includes ensemble methods with probabilistic models for performing inferences, forecasts, and classifications using the beneficiary business data.

11. The method of claim 10 wherein the probabilistic models are pre-trained or includes transference learning to increase speed and precision of model convergence using the beneficiary business data.

12. The method of claim 10 wherein the probabilistic models include Bayesian Regression.

13. The method of claim 10 wherein the probabilistic models include supervised or unsupervised machine learning clustering algorithms.

14. The method of claim 13 wherein the supervised machine learning clustering algorithms include at least one of Support Vector Machines, Nearest Neighbors, Decision Tree, Random Forest, Neural Networks, Deep Neural Networks, AdaBoost, and QDA.

15. The method of claim 9 wherein the recommending includes providing at least one of reporting, tasking, analytics and market analysis.

16. The method of claim 9 wherein the recognizing includes identifying a breach in expected performance of beneficiary business metrics and quantifying beneficiary business performance against historical data and selected benchmarks, and wherein the recommending includes providing informed decisions related to the beneficiary business model.
